(19) United States
(12) Patent Application Publication
(10) Pub. No.: US 2012/0126553 A1
(43) Pub. Date: May 24, 2012

(54) BUMPER CROSS MEMBER FOR A MOTOR VEHICLE, REINFORCEMENT COMPONENT FOR A BUMPER CROSS MEMBER AND METHOD FOR PRODUCING A BUMPER CROSS MEMBER

(75) Inventors: Udo MILDNER, Limburg (DE); Lothar TESKE, Aschaffenburg (DE)

(73) Assignee: GM GLOBAL TECHNOLOGY OPERATIONS LLC, Detroit, MI (US)

(21) Appl. No.: 13/293,178

(22) Filed: Nov. 10, 2011

(30) Foreign Application Priority Data
Nov. 10, 2010 (DE) 102010050960.4

(51) Int. Cl. B60R 19/02; B23P 15/00; B21D 5/12

(52) U.S. Cl. 293/102; 72/176; 29/897.2; 72/177

(57) ABSTRACT

A bumper cross member for a motor vehicle includes, but is not limited to a first chamber located in driving direction at the front and a second chamber located in driving direction behind the first chamber. The first and the second chamber are embodied as hollow sheet metal profiles and the first chamber has a higher deformability than the second chamber.

### CROSS-REFERENCE TO RELATED APPLICATION

This application claims priority to German Patent Application No. 102010050960.4, filed Nov. 10, 2010, which is incorporated herein by reference in its entirety.

### TECHNICAL FIELD

The technical field relates to a bumper cross member for a vehicle and a reinforcement component for a bumper cross member. Furthermore, the technical field relates to a method suitable for producing the bumper cross member.

### BACKGROUND

The bumper cross member of a motor vehicle with the components mounted thereon has the objective of absorbing deformation energy and parts of the vehicle located inside, such as for example the engine, in the event of a collision. For a number of reasons, certain requirements with regard to the deformability have to be satisfied.

Frequently, compressible foams with a thickness of 6 cm to 7 cm are therefore frequently mounted to the bumper cross member. These decisively contribute to the so-called front overhang of a vehicle, which is defined as the distance between the center point of the front wheel and the front-most contour of the bumper covering. A reduction of the front overhang and thus a particularly compact design is the endeavor with modern motor vehicles.

From DE 10 2004 024 468 A1 an impact-damping component arrangement for a motor vehicle is known. Instead of a compressible foam a horizontally running butting wall is inserted in front of the bumper cross member.

Therefore, at least one object is to state a bumper cross member for a motor vehicle, which allows a reduction of the front overhang and which can be simultaneously produced economically and in a technically simple manner. In addition, it is at least a further object to state a particularly economical method for producing a bumper cross member for a motor vehicle. In addition, other objects, desirable features and characteristics will become apparent from the subsequent summary and detailed description, and the appended claims, taken in conjunction with the accompanying drawings and this background.

### SUMMARY

A bumper cross member is provided for a motor vehicle. The bumper cross member comprises at least one first chamber in driving direction located at the front and a second chamber located in driving direction behind the first chamber. The first and the second chamber are designed as hollow sheet metal profiles and the first chamber has a higher deformability than the second chamber. Here, the side located in front in driving direction describes that side which is first exposed to a deformation in the event of a head-on collision. Thus, the driving direction can also be defined with regard to parts not yet mounted in the vehicle, since for these the orientation later on and the behavior in the event of a crash are also already determined.

Deformability here and in the following is to mean the characteristic of a component of being able to absorb deformation energy. A higher deformability of a component thus means a greater resultant deformation upon the action of identical forces. The bumper cross member has the advantage that because of the high deformability of the first chamber it guarantees the pedestrian protection while at the same time it offers a good protection of parts of the vehicle located inside through the higher stiffness of the second chamber.

In this way it is possible to replace the frequently usual deformable foams with a component which on the one hand can be produced particularly easily and on the other hand can also be designed in a space-saving manner so that it makes possible a reduction of the front overhang with good functionality that remains the same. Furthermore, the bumper cross member has the advantage that the deformation behavior of such a metallic chamber can be well calculated and repeatedly verified experimentally. Thus, the deformation behavior that is necessary can be very precisely defined.

In an embodiment, the first and the second chamber are unitarily formed of a continuous metal sheet. A bumper cross member according to this embodiment can more preferably be produced by the roll-forming method. Following the finish forming of the bumper cross member the open ends are welded so that a closed hollow profile is created.

The deformability of the two chambers can be influenced in various manners. A high deformability of the first chamber is achieved in an embodiment in that or among other things in that the metal sheet in the region of the first chamber has a smaller wall thickness than the metal sheet in the region of the second chamber. Alternatively or additionally the metal sheet can have a number of through-holes increasing the deformability in the region of the first chamber. The number, size and arrangement of the holes can more preferably be determined through finite element simulation. Alternatively or additionally, the bumper cross member can have a reinforcement component arranged in the region of the second chamber, which for example is embodied as plastic injection molding and can have a honeycomb structure.

With the roll-forming method, especially profiles running in a straight line can be created. For this reason, a bumper is typically subjected to a bending operation after the roll-forming method in order to match it to the contour of the bumper covering. When a reinforcement part is used and this is to be introduced into the second chamber prior to the bending operation, it is advantageous when the reinforcement component comprises a number of wedge-shaped recesses on one of its longitudinal sides which facilitate bending.

A motor vehicle is also provided with the described bumper cross member. A reinforcement component is also provided for a bumper cross member of a motor vehicle. The reinforcement component is formed of plastic and intended for insertion in a chamber of the bumper cross member. The reinforcement component has the advantage that it allows a targeted influencing of the deformation characteristics of the bumper cross member and more preferably a stiffening of the chamber receiving the reinforcement component. Since the reinforcement component is intended for insertion in the chamber, its outer contour is matched to the inner contour of the bumper cross member.

The reinforcement component can more preferably be designed as honeycomb-structured plastic injection molding. The honeycomb structure in this case allows a light-weight and at the same time stiff construction of the reinforcement component. In an embodiment, the reinforcement component has a number of wedge-shaped recesses on one of its longitudinal sides. These allow a bending of the reinforcement component when it is inserted in the chamber of the bumper cross member.

According to a further embodiment, a method is provided for producing a bumper cross member for a motor vehicle. The bumper cross member comprises at least one first chamber located in driving direction at the front and a second chamber located in driving direction behind the first chamber. The method, here, comprises providing a metal sheet having a first region intended for forming the first chamber and a second region intended for forming the second chamber; forming of the metal sheet by the roll-forming method subject to the formation of the first chamber and the second chamber and subject to the welding of the open ends.

In an embodiment, a material thickness of the metal sheet that is greater than in the first region is created in the second region by a rolling process and/or by welding together a plurality of metal sheet layers. Through this it is achieved that the deformability of the first chamber is greater than that of the second chamber. Alternatively or additionally, a reinforcement component can also be introduced into the second chamber. Such a reinforcement component then lies in the interior of the hollow profile forming the bumper cross member and can influence the deformation characteristic of the second chamber in the desired manner. In an embodiment, the bumper cross member after completion of the roll-forming method is matched to the contour of a bumper covering through bending.

### BRIEF DESCRIPTION OF THE DRAWINGS

The present invention will hereinafter be described in conjunction with the following drawing figures, wherein like numerals denote like elements, and:

FIG. 1 schematically shows a motor vehicle with a bumper cross member according to an embodiment;

FIG. 2 schematically shows the bumper cross member according to FIG. 1 in a perspective view;

FIG. 3 schematically shows a cross section through the bumper cross member according to FIG. 2;

FIG. 4 schematically shows a cross section through a bumper cross member according to a second embodiment;

FIG. 5 schematically shows a cross section through a bumper cross member according to a third embodiment;

FIG. 6 schematically shows a further perspective view of the bumper cross member according to FIG. 1;

FIG. 7 schematically shows a reinforcement component for a bumper cross member;

FIG. 8 schematically shows a longitudinal section through a bumper cross member with installed reinforcement component;

FIG. 9 schematically shows a longitudinal section through the reinforcement component before a bending process; and

FIG. 10 schematically shows a longitudinal section through the reinforcement component after a bending process.

### DETAILED DESCRIPTION

The following detailed description is merely exemplary in nature and is not intended to limit application and uses. Furthermore, there is no intention to be bound by any theory presented in the preceding background or summary or the following detailed description.

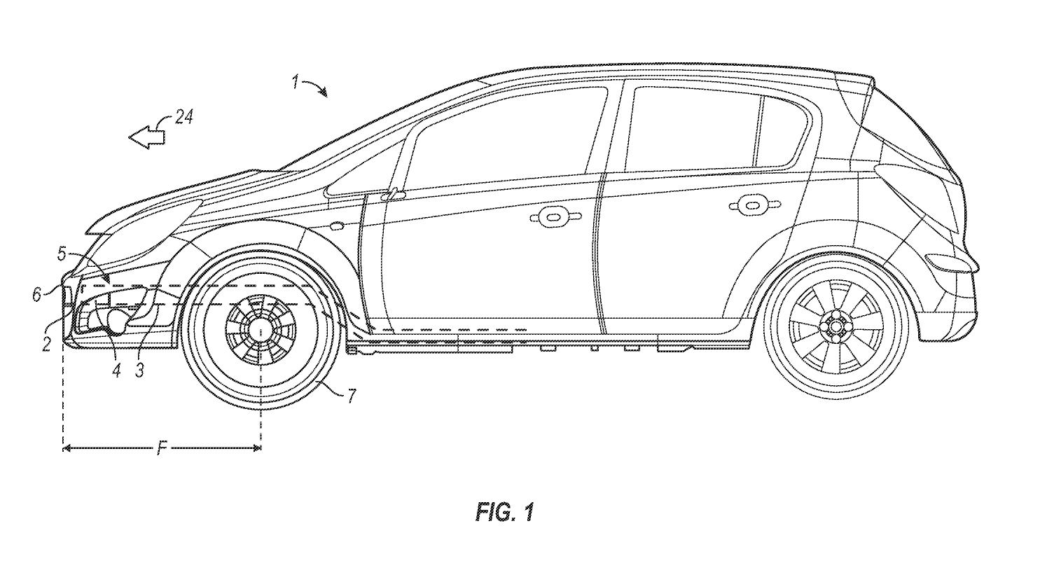

FIG. 1 shows a motor vehicle 1 with a bumper cross member 2 arranged in the front region of the motor vehicle 1. The bumper cross member 2 is mounted on side members 3 in the known manner by means of crash boxes 4 and has the objective of protecting components accommodated in the engine compartment of the motor vehicle 1 in the event of an impact.

An important design quantity with motor vehicles is the front overhang F, which is defined as distance between the center point of the front wheel 7 and the outermost contour 6 of the bumper overhang 5. Through the particular configuration of the bumper cross member 2, which is described in the following figures, a particularly small front overhang F can be realized. Here and in the following figures, the arrow 24 marks the typical driving direction of the motor vehicle 1 for better orientation.

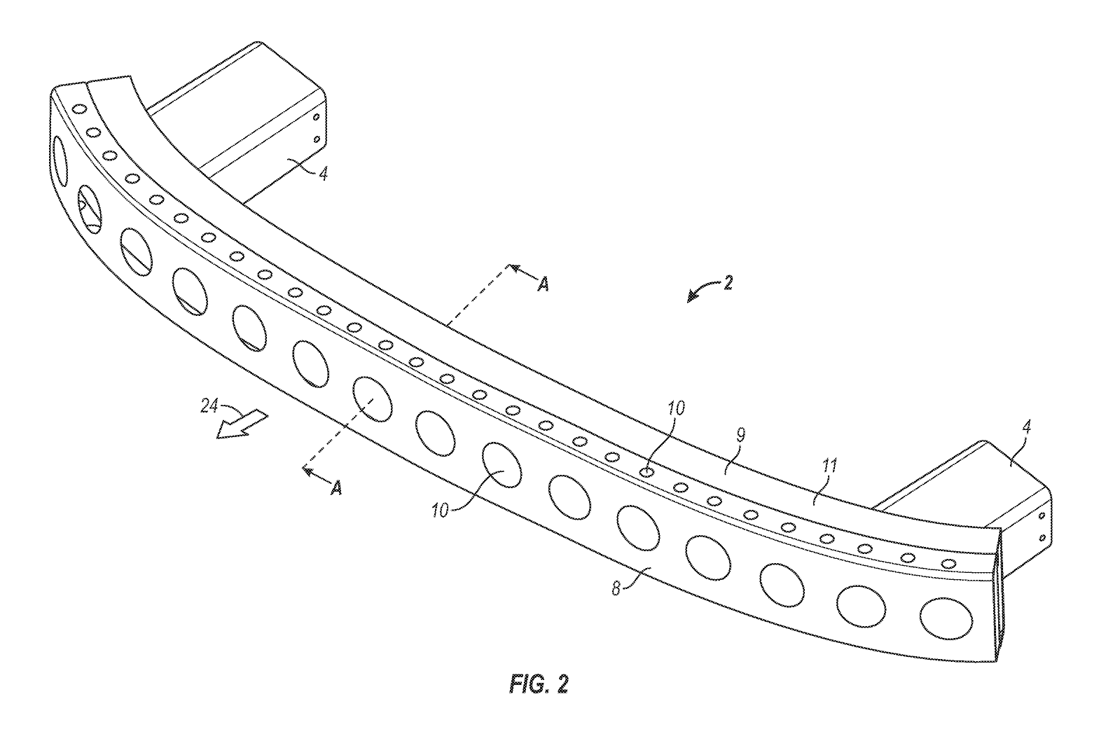

FIG. 2 shows a perspective view of the bumper cross member 2, in which the two crash boxes 4 are noticeable. The bumper cross member 2 is formed of a single metal sheet 11 by the roll-forming method. The metal sheet 11 is bent into a hollow profile and forms a first chamber 8 and a second chamber 9, wherein the first chamber 8 in driving direction is arranged in front of the second chamber 9. In the region of the first chamber 8, the metal sheet 11 has a number of through-holes 10, which increase the deformability of the metal sheet 11 in this region. The first chamber 8 has a higher deformability than the second chamber 9.

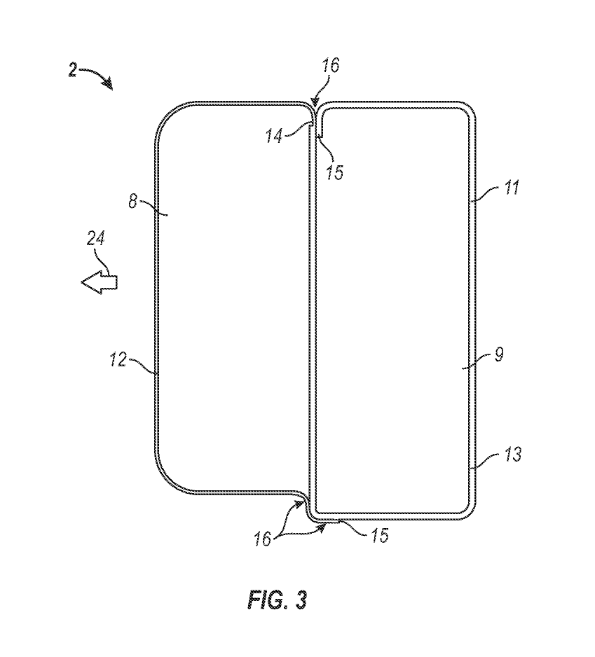

FIG. 3 shows a cross section through the bumper cross member 2 along the section line A-A from FIG. 2. In this view it is evident how the bumper cross member 2 is bent of the single metal sheet 11. The metal sheet 11 to this end is provided as a strip wound on a coil which over its width has different material thicknesses. The metal sheet can more preferably consist of an aluminum material or steel. In a first region 12 provided for forming the first chamber 8 the metal sheet 11 is thinner than in a second region 13 provided for forming the second chamber 9.

If the metal sheet consists of an aluminum material, the material thickness of the first region 12 for example amounts to approximately 0.8 to 1 mm and that of the second region 13, approximately 3 to 4 mm. If it consists of steel, it amounts to approximately 0.6 to 0.7 mm in the first region 12 and in the second region 13, to approximately 1.5 to 2.5 mm. The differences in the material thickness can for example be created in a rolling process or by welding a plurality of metal sheets on top of one another.

The sheet metal strip is then formed into the profile consisting of the two chambers 8, 9 by the roll-forming method. In an embodiment that is not shown, the profile has three or more chambers. The forming is carried out in such a manner that a transition region 14 of the metal sheet 11 between the first region 12 and the second region 13 comes to lie between the first chamber 8 and the second chamber 9. The free ends 15 of the metal sheet 11 are each joined with the metal sheet 11 with weld seams 16 by means of laser, friction and/or CO₂ welding. Straight-line profiles are typically produced by the roll-forming method. In order to match the bumper cross member 2 to the contour of the bumper covering 5, the former is subjected to a bending operation after completion of the roll-forming method. In the embodiment shown in FIG. 3, the chambers 8, 9 have a rectangular cross section. Other shapes, for example square, round, oval or half-round cross sections and combinations thereof are also conceivable.

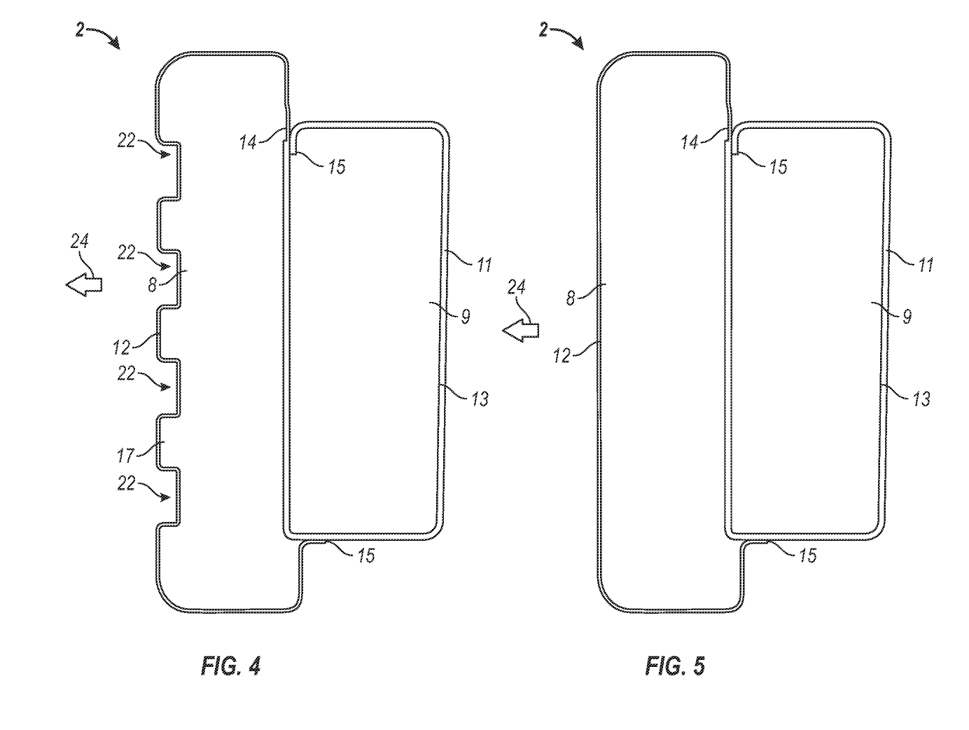

Further possible embodiments of the chambers 8, 9 are shown in the FIG. 4 and FIG. 5. FIG. 4 shows a cross section through a bumper cross member 2 according to a second embodiment, which differs from the one shown in FIG. 3 in that the first chamber 8 is flatter and higher than the second chamber 9. In addition to this, the front side 17 of the bumper cross member 2 has a number of depressions 22, which increase the deformation characteristics of the first chamber 8.

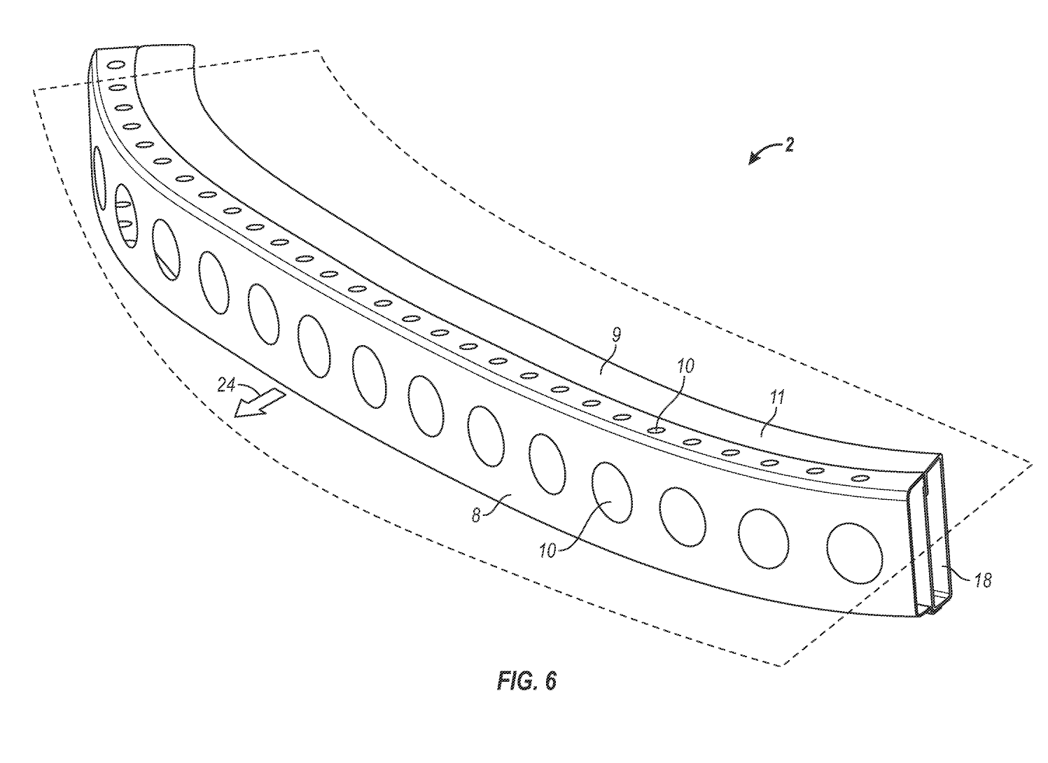

FIG. 5 shows a cross section through a further embodiment of a bumper cross member 2 according to a third embodiment, which differs from the one shown in FIG. 4 by the absence of the depressions 22. FIG. 6 shows a perspective view of the bumper cross member 2 with a section plane B-B. With this embodiment a reinforcement component 18 is inserted in the second chamber 9.

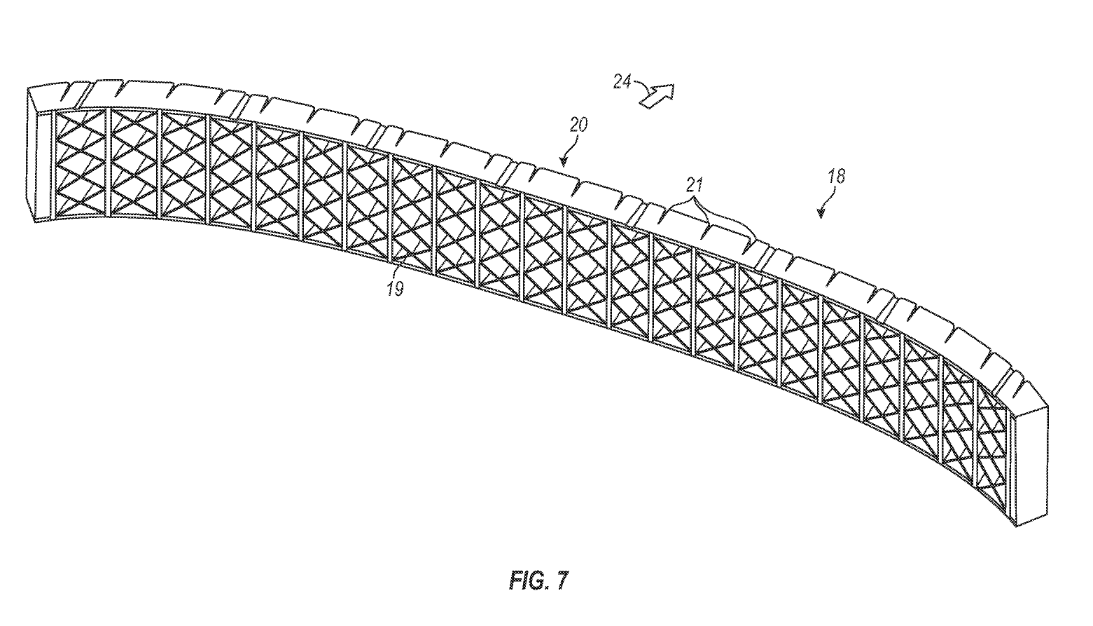

FIG. 7 shows a perspective view of a reinforcement component 18, which is intended for insertion in the second chamber 9 of the bumper cross member 2. It is embodied as plastic injection molding and has a honeycomb structure 19. The reinforcement component 18 in FIG. 7 is already shown bent and thus matched to the contour of the bumper covering 5. So as to facilitate bending without destruction of the reinforcement component 18, the reinforcement component 18 has a multiplicity of wedge-shaped recesses 21 on a longitudinal side 20, which with the embodiment shown are provided in such a manner that they open up during the bending operation.

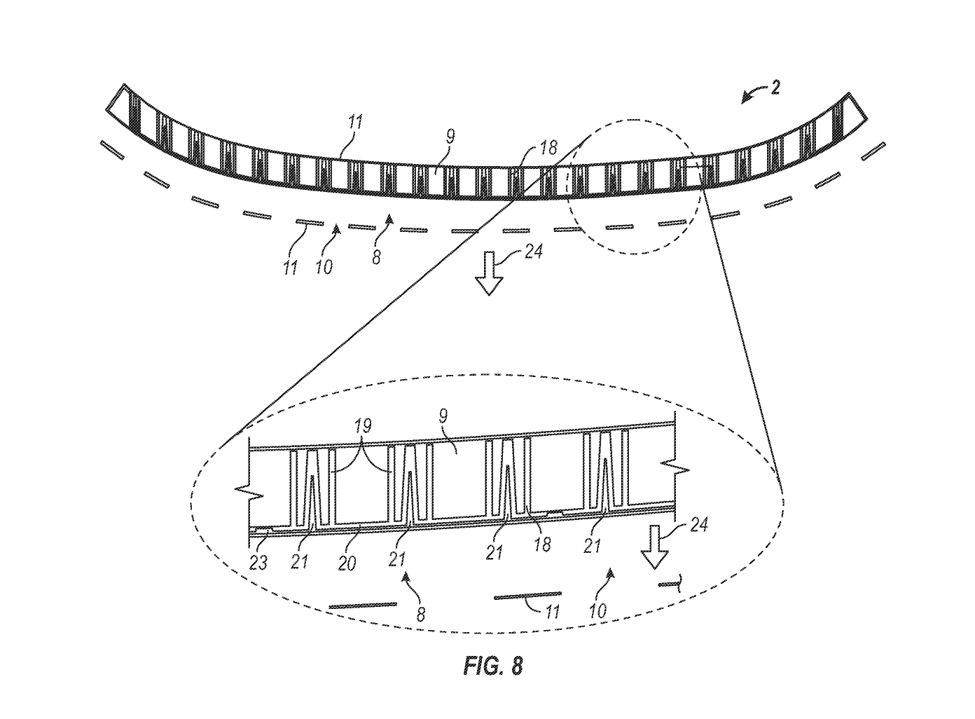

FIG. 8 shows a longitudinal section through the bumper cross member 2 along the section plane B-B from FIG. 6 with reinforcement component 18 inserted in the second chamber 9. In the detail representation in the lower Figure half a U-shaped channel 23 is evident, which is provided for receiving an adhesive that expands under the influence of heat. By means of such an adhesive the reinforcement component 18 can be connected to the metal sheet 11 in a fixed manner.

The reinforcement component 18 increases the stiffness of the second chamber 9 and thus reduces its deformability. The material thickness of the metal sheet 11 can thus be selected smaller than in the first region 13. When using an aluminum material for the metal sheet 11, it amounts for example to approximately 2 to 3 mm and when using steel, approximately 1.2 to 2 mm.

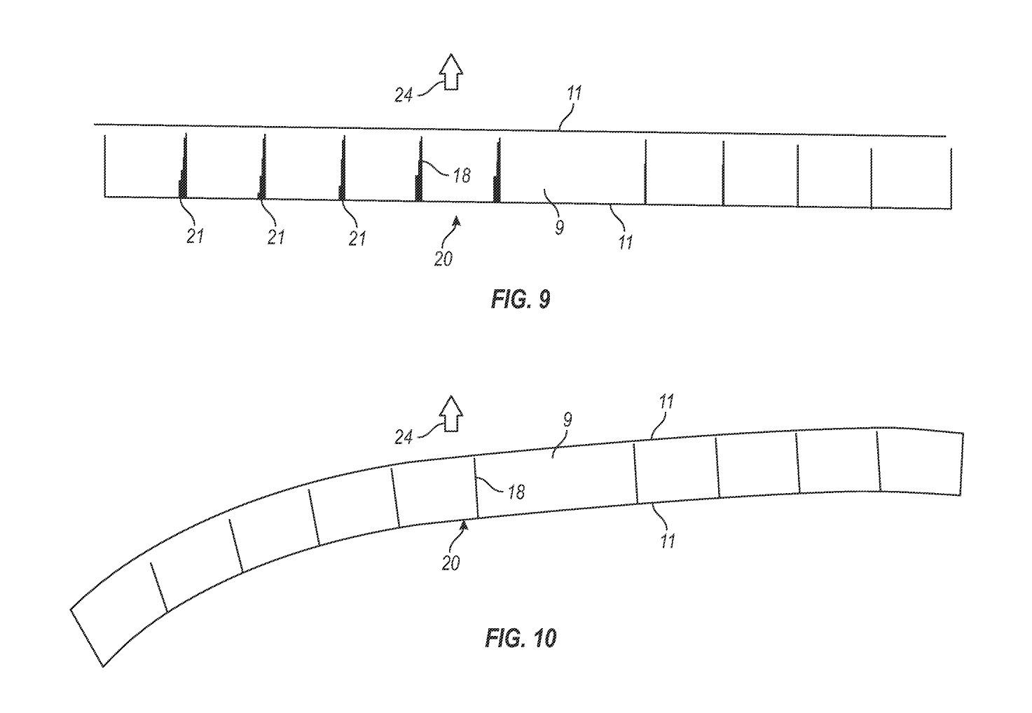

The FIG. 9 and FIG. 10 schematically show the behavior of the reinforcement component 18 during the bending operation of the bumper cross member 2. With the shown embodiment, the wedge-shaped recesses 21 are introduced in the other longitudinal side 20 of the reinforcement component 18, so that these do not open during bending, but close.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A bumper cross member for a motor vehicle, comprising:
a first chamber located in a driving direction at a front; and
a second chamber located in the driving direction behind the first chamber,
wherein the first chamber and the second chamber are hollow sheet metal profiles and the first chamber has a higher deformability than the second chamber.

2. The bumper cross member according to claim 1, wherein the first chamber and the second chamber are unitarily formed from a continuous metal sheet.

3. The bumper cross member according to claim 2, wherein the continuous metal sheet in a region of the first chamber has a smaller wall thickness than the continuous metal sheet in a second region of the second chamber.

4. The bumper cross member according to claim 2, wherein the continuous metal sheet in a region of the first chamber has a number of through-holes increasing deformability.

5. The bumper cross member according to claim 1, further comprising a reinforcement component arranged in a region of the second chamber.

6. The bumper cross member according to claim 5, wherein the reinforcement component is a plastic injection molding.

7. The bumper cross member according to claim 5, wherein the reinforcement component on a longitudinal side comprises a plurality of wedge-shaped recesses.

8. A motor vehicle, comprising:
a vehicle body; and
a bumper cross member on a front of the vehicle body, the bumper cross member comprising:
a first chamber located in a driving direction at a front; and
a second chamber located in the driving direction behind the first chamber,
wherein the first chamber and the second chamber are hollow sheet metal profiles and the first chamber has a higher deformability than the second chamber.

9. The motor vehicle according to claim 8, wherein the first chamber and the second chamber are unitarily formed from a continuous metal sheet.

10. The motor vehicle according to claim 9, wherein the continuous metal sheet in a region of the first chamber has a smaller wall thickness than the continuous metal sheet in a second region of the second chamber.

11. The motor vehicle according to claim 9, wherein the continuous metal sheet in a region of the first chamber has a number of through-holes increasing deformability.

12. The motor vehicle according to claim 8, further comprising a reinforcement component arranged in a region of the second chamber.

13. The motor vehicle according to claim 12, wherein the reinforcement component is a plastic injection molding.

14. The motor vehicle according to claim 12, wherein the reinforcement component on a longitudinal side comprises a plurality of wedge-shaped recesses.

15. A method for producing a bumper cross member for a motor vehicle, the bumper cross member comprising a first chamber located in a driving direction at the front and a second chamber located in the driving direction behind the first chamber, the method comprising:
providing a metal sheet with a first region configured to form the first chamber and a second region configured to form the second chamber; and
forming of the metal sheet by roll-forming subject to formation of the first chamber and of the second chamber and subject to welding of open ends.

16. The method according to claim 15, wherein in the second region in a rolling process together of a plurality of metal sheet layers, the method further comprises creating a material thickness of the metal sheet that is greater than in the first region.

17. The method according to claim 15, wherein in the second region in a welding together of a plurality of metal sheet layers, the method further comprises creating a material thickness of the metal sheet that is greater than in the first region .

18. The method according to claim 15, further comprising introducing a reinforcement component in the second chamber.

19. The method according to claim 15, further comprising matching the bumper cross member to a contour of a bumper covering through bending after completion of the roll-forming.
